(19) United States
(12) Patent Application Publication
(10) Pub. No.: US 2019/0019231 A1
(43) Pub. Date: Jan. 17, 2019

(54) A System for Facilitating the Provision of Feedback

(71) Applicant: Ian Alistair Bray, Lee-on-Solent, Hampshire (GB)

(72) Inventor: Ian Alistair Bray, Lee-on-Solent, Hampshire (GB)

(21) Appl. No.: 16/067,206

(22) PCT Filed: Dec. 23, 2016
(86) PCT No.: PCT/GB2016/054063

§ 371 Date: Jun. 29, 2018

Related U.S. Application Data
(60) Provisional application No. 62/272,697, filed on Dec. 30, 2015.

(51) Int. Cl. G06Q 30/02

(52) U.S. Cl. CPC G06Q 30/0282; G06Q 30/0201

(57) ABSTRACT

A method and apparatus utilized in operating a feedback system in a digital environment is described. Instead of allowing users of the system to enter free-form comments for and about other users, or rating other users of the system on a sliding scale, a number of Semantic Terms (single adjectives or short descriptive phrases) are provided that relate to the transaction undertaken between the users, with the capability for users to define new Semantic Terms to add to the system. Users leaving feedback for other users are permitted to select a number of these Semantic Terms, or add their own Semantic terms to the system, to describe the user relative to the transaction undertaken. The Semantic Terms are associated with the users whom the comment pertains to, and can be utilized by other users of the system when seeking to engage other users in a transaction as qualifiers or filters.

### BACKGROUND

### 1. Field of Invention

The present invention relates to a system for facilitating the provision of feedback particularly, but not limited to, providing reviews following the completion of an interaction between two parties involving goods and/or services, utilizing semantic terms for the provision of feedback en lieu of free-form comments or sliding scale ratings.

Since the emergence of electronic commerce platforms, feedback systems have been derivatively based providing either free-form comments or sliding scale ratings to provide a review of a product, service, interaction, transaction or other uses. In a typical interaction, a user either engages in purchasing goods, or engaging a service to be provided, and then provides feedback on that system.

Prior art FIG. 1. provides an example of a feedback that may be displayed about a user. Information that could be used to identify a user has been masked in this figure. As marked in 101, the sliding scale rating a User has been given by another User—in this case a rating on a scale of 1 to 5 stars. As marked in 102, a free-form comment review has been provided, detailing their experience with this User. Each sliding scale score and comment about this User are displayed chronologically with newest reviews at the top of the web page for that User.

Prior art FIG. 2. provides an example of a feedback system that may be displayed to a user who desires to leave a sliding scale rating about another user (identifying information about the User being reviewed has been redacted). In area 201 the details of the transaction undertaken are shown, in area 202 the details of the User being reviewed (in this case, a taxi driver) are displayed. In area 203 the user is asked to provide a sliding scale rating of the reviewing User's experience—in this case a sliding scale of 1 to 5 stars. Once the User selects the sliding scale value they wish to leave as feedback, the feedback is automatically submitted and associated in the system between the both parties in the transaction.

Prior art FIG. 3. provides an example of a feedback system that may be displayed to a user who desires to leave a sliding scale rating about another user in combination with free-form comments (identifying information about the User being reviewed has been redacted). In area 301 the User is prompted to select a rating on a slide scale (1 to 5 stars), and then provide free-form comment feedback in box 302. When the User is happy with the feedback they wish to leave for this, they click on button 303 to submit the feedback, and this is associated in the system between the both parties in the transaction.

The issues with sliding scale feedback systems as shown in Prior Art FIG. 1, FIG. 2 and FIG. 3 is that they ask humans to relate an experience in an arbitrary fashion which can cause inarticulate feedback and can lead to the feedback being skewed either by the reviewed party asking for favourable scores, or overly negative reviews in an attempt to enact punitive measures over a minor point of the review by affecting the average ranking.

The issues with free-form comment feedback systems is that they cannot easily be broken down by dependent systems to ascertain common trends in reviewing criteria. Additionally, the slander and libel laws of Great Britain, Europe and Middle Eastern states, can lead to the publishing of comments that may be viewed as in breach of local legal frameworks.

Combining these two systems as shown in FIG. 1 and FIG. 3 has become the predominant system for collating feedback in electronic systems throughout the world but doing so does not ameliorate the drawbacks that both systems have, leading to an inflationary effect on sliding scale scores and generic freeform comments being utilized.

### SUMMARY OF INVENTION

The object of the present invention is to provide an improved system for facilitating the provision of feedback. According to the present invention there is provided a system for facilitating the provision of feedback, the system comprising:
a computing means, and
an application resident on the computing means, the application:
   defining a list of predetermined review terms,
   being adapted to:
      display remotely a review form,
      receive at the server selections from the list in accordance with reviews made via the form,
      statistically analyse the reviews and store statistics thereof on the server, and
      make the statistics available for inspection.

Additionally, there is also provided a method to facilitate the operation of a feedback system wherein a reviewer can review a reviewee, the method comprising of the following steps, the feedback system:
displaying to the reviewer a review form,
enabling the reviewer to select one or more predetermined review terms from the review form based on the goods and/or services provided by the supplier,
receiving the selection of review terms made by the reviewer,
statistically analysing the review terms selected by the reviewer and storing the statistics thereof, and
making the statistics available for inspection.

As used herein, the term reviewer is used to refer to any individual that may wish to leave a review, and reviewee is used to refer to any individual or provider being reviewed. The reviewer-reviewee relationship can be, but is not limited to consumer supplier, peer to peer or any other scenario wherein a review may be appropriate. Just as a consumer may review a supplier, a supplier may review a consumer.

As used herein, the term consumer is used to refer to any individual that may use a service provided by a supplier. This will, generally, be a member of the public. The supplier may be regarded as an individual or entity supplying goods or services, such as, but not limited to a retailer, or handy-man.

As used herein, the terms semantic terms and review terms are used interchangeably. In the present invention all review terms will be semantic terms, such as descriptors or phrases for use in providing a review through the review form.

As used herein, the term transaction and interaction are used interchangeably. In the present invention two parties may interact via means provided in the present invention. The feedback system has provisions to determine whether the interaction between the parties has resulted in an event for which feedback may be justifiably given.

The computing means the application is resident upon can vary. Normally the application will be resident upon a server, preferably a remotely accessible server. Alternatively, it is envisaged a distrusted ledger model may be implemented.

Instead of allowing users of the system to enter free-form comments for and about other users or rating other users of the system on a sliding scale, a number of Semantic Terms (single adjectives or short descriptive phrases) are provided that relate to the transaction undertaken between the users, with the capability for users to define new Semantic Terms to add to the system. Users leaving feedback for other users are permitted to select a number of these Semantic Terms, or add their own Semantic terms to the system, to describe the user relative to the transaction undertaken. The Semantic Terms are associated with the users whom the comment pertains to, and can be utilized by other users of the system when seeking to engage other users in a transaction as qualifiers or filters during the search.

Other features of the present invention will be apparent from the accompanying drawings and from the detailed description that follows.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a prior art illustration of an online feedback system listing comments about a user of an eCommerce service.

FIG. 2 is a prior art illustration of an online feedback system that is utilized by one user to rate another user on a sliding scale which in this case is 1 to 5 stars.

FIG. 3 is a prior art illustration of an online feedback system that is utilized by one user to rate another user on a sliding scale which in this case is 1 to 5 stars and, in addition, add free-form comments to the feedback.

FIG. 4 is an illustration of an exemplary Computer System on which variants of the invention may be practiced.

FIG. 5 is an illustration of online feedback system via a web site through which variants of the invention may be practised.

FIG. 6 is an illustration of online feedback system via an application on a tablet of smart phone through which variants of the invention may be practised.

FIG. 7 is an illustration of the described invention with an exemplary database structure for an online service which FIG. 4 or FIG. 5 represents.

FIG. 8 is a flowchart illustrating an exemplary method for operating a feedback system incorporating the invention.

FIG. 9 is a flowchart illustrating an alternative exemplary method for operating a feedback system incorporating the invention where there is specific definition of either side of the transaction as a Service Supplier (the party who provided the Service or Goods) and a Service Consumer (the party who consumed the Service or Goods).

FIG. 10 is an illustration of an exemplary application architecture for an online service which FIG. 4 or FIG. 5 represents.

FIG. 11 is an illustration of an exemplary User Profile detailing the Feedback left for the User.

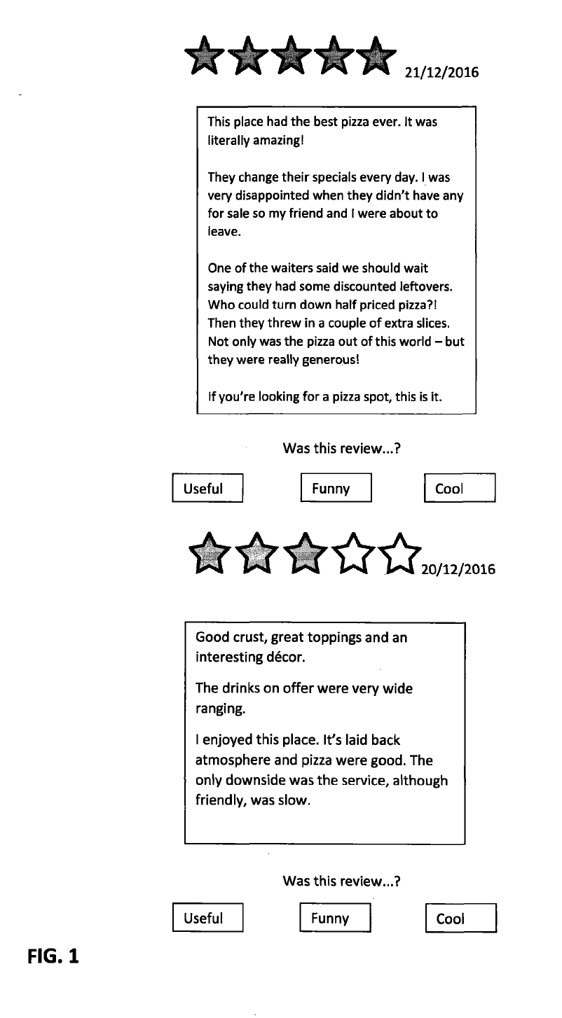

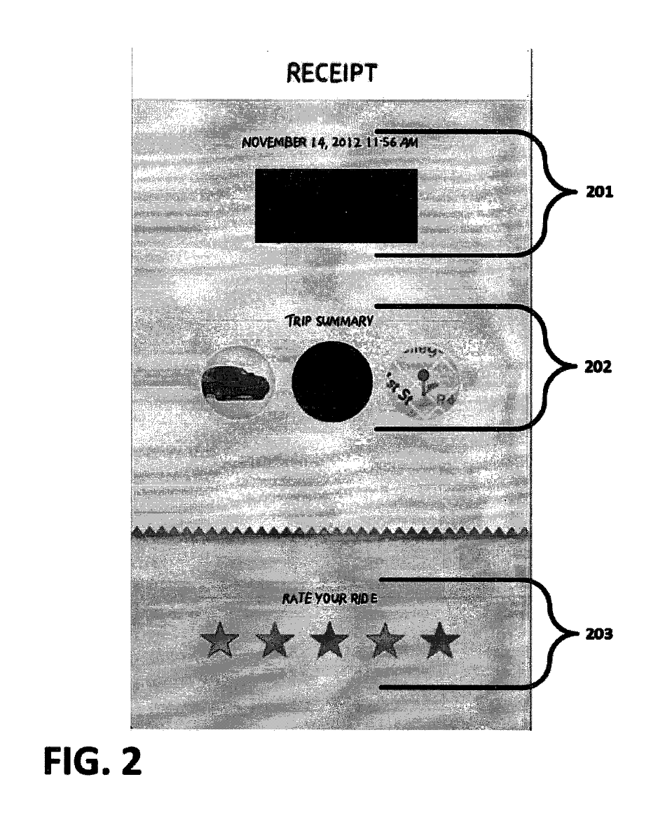

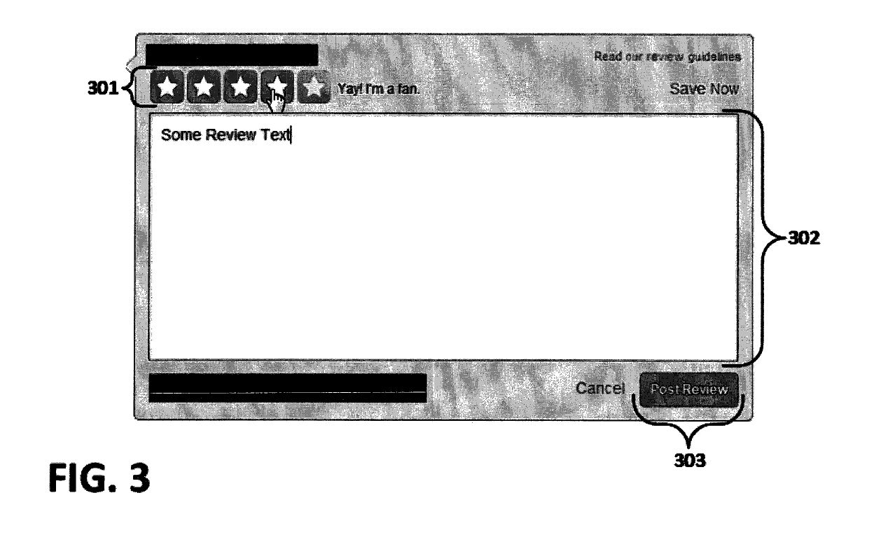

### DETAILED DESCRIPTION OF THE INVENTION

A method and apparatus are described to facilitate the operation of a feedback system in a digital environment wherein Semantic Terms (adjectives or short descriptive phrases) are selected by a user from a predefined set presented to the user as, for example, a menu with the capability for a user to suggest additional Semantic Terms for inclusion into the set. Compared with prior art feedback systems, variants of the invention facilitate the efficient use of storage space by storing the Semantic Terms a minimum number of times. In the following description, for the purposes of explanation, specific details are set forth in order to provide a thorough understanding of the present invention.

### Exemplary Computer System

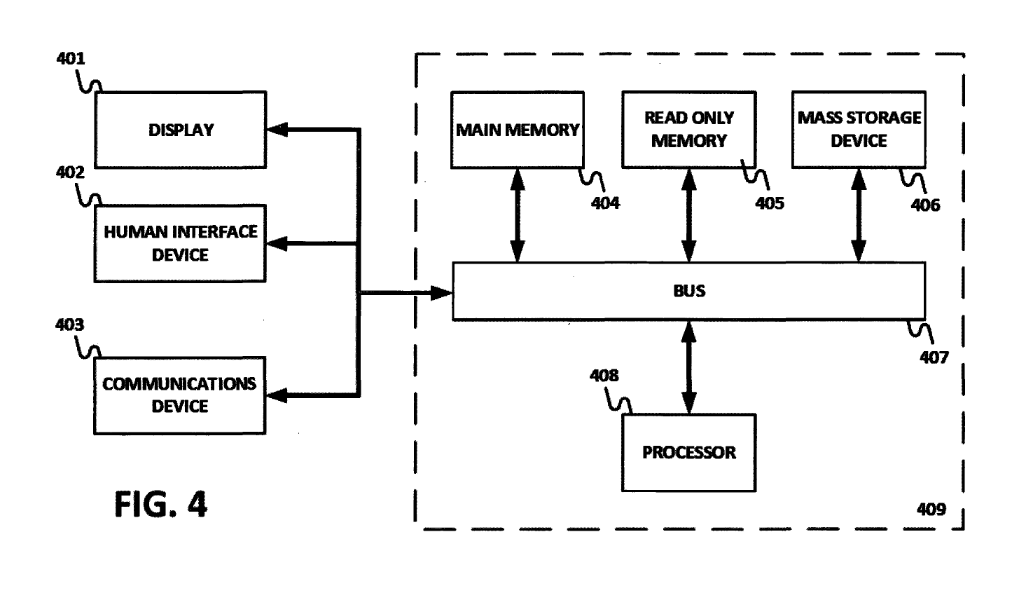

FIG. 4 is an example of a typical Computer System upon which various variants of the present invention may be practiced. In the various variants, Computer System 409 may be utilized as a server (that is a computing system that provides services to other client devices) on which information including feedback information about the various users of an online service platform system are stored. Furthermore, Computer System 409 may be used directly by a user to participate in engaging with other users of the system to undertake a commercial transaction—whether that be an exchange of physical goods or exchange of services, including examination of feedback and leaving feedback for other users.

The Computer System represented (409) comprises of a Bus or other communications means (407) for communicating information, and a processing means such as a Processor (408) coupled with the Bus (407) for processing information. The Computer System represented in (409) further comprises of Random Access Memory (RAM), Flash memory, or other means of dynamic storage device (404)—referred to as Main Memory—coupled to the Bus (407) for storing information and instructions to be executed by Processor (408). Main Memory (404) also may be used to store dynamic information such as temporary variables or other intermediate information states during execution of instructions by Processor (408).

The represented Computer System (409) may also comprise of Read-Only Memory (ROM) and/or other static storage devices (405) coupled to the Bus (407) for storing static information and instructions for Processor (408). A Mass Storage Device (406) such as a magnetic hard disk, optical storage disk, or solid state flash memory disk (SSD) and its corresponding drive may also be coupled to the represented Computer System (409) for storing information and instructions. In some architectures a single memory device may perform the functions of two or more of the ROM (405), the Main Memory (404) and the Mass Storage Device (406). In other architectures, such as might be implemented with a Server, the system may be implemented with multiple Mass Storage Devices (406).

The exemplary Computer System (409) can also be coupled via the Bus (407) to a Display device (401) such as a Liquid Crystal Display (LCD), Cathode Ray Tube (CRT) or Organic Light Emitting Diode (OLED) to display information to an end user. Typically, a Human Interface Device (402) such as an alphanumeric input device, cursor direction keys, mouse, trackball or touch sensitive screen may be coupled to the Bus (407) for communicating information and/or commands to Processor (408) and for controlling cursor movement on the Display (401).

A Communications Device (403) may also be coupled to the Bus (407). This Communications Device (403) may include a modem, network interface card, or other well-known interface device such as an Ethernet adapter, Wireless Network Card, or other types of physical or wireless communication component to support a local or wide-area network. In this manner, the exemplary Computer System (409) may be connected to a number of client devices and/or servers via a network infrastructure, such as the Internet.

It is appreciated that it may be desirable for certain implementations for a lesser or more equipped computer system than the example described above. Therefore the configuration of Computer System (409) will vary from implementation to implementation depending variables such as performance requirements, technological improvements, use cases, price constraints and/or other circumstances. It should also be noted that while operations described may be performed under the control of a programmed processor such as Processor (408), in alternative variants, the operations may be fully or partially implemented by any programmable or hard-coded logic system, such as a Field Programmable Gate Array (FPGA), TTL Logic, or Application Specific Integrated Circuit (ASIC). Additionally, the method of the present invention may be performed by any combination of programmed general-purpose computing components and/or customized hardware components. Therefore, nothing disclosed herein should be construed as a limiting factor in regard to the present invention to a particular variant wherein the steps recited are performed by a specific hardware component combination.

### Exemplary Review System

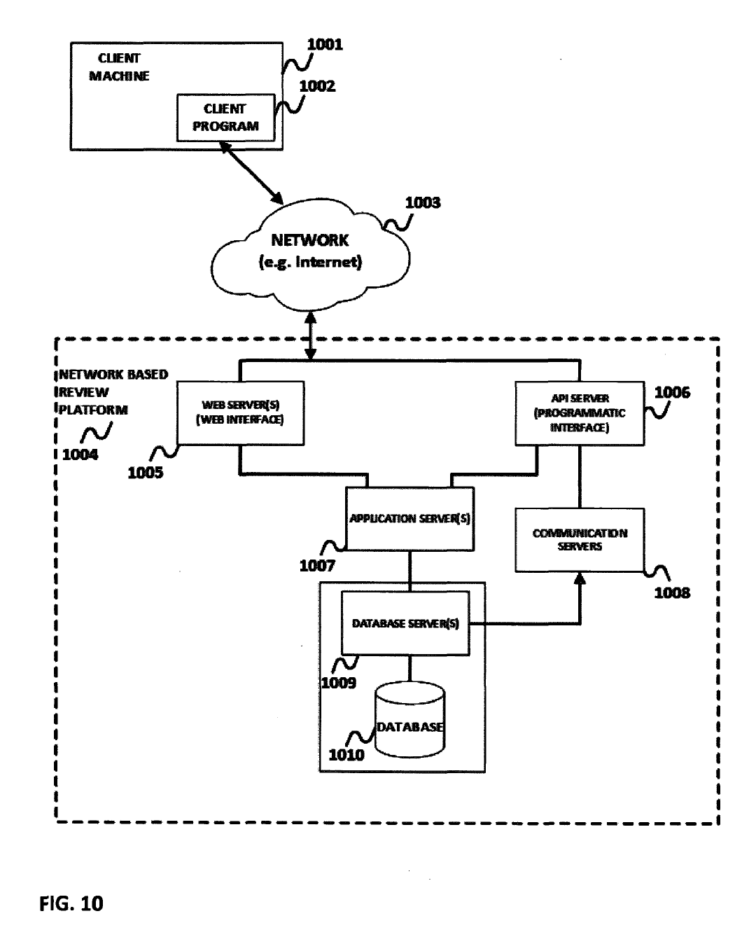

FIG. 10 is a block diagram illustrating an exemplary network-based feedback system in the form of a Review Platform (1004) on which variants of the invention may be practiced. While exemplary variants of this invention are described within the context of a Review Platform (that is a website that allows users to review products and services offered by other users), it will be appreciated by those skilled in the art that the invention will find application in many different types of e-commerce facilities, including as a sub-component of a larger facility.

The Review Platform (1004) includes one or more of a number of types of front-end servers, namely a Web Server (1005) that delivers Web pages (e.g. documents of mark-up language), and an API Server (1006), that provides an intelligent Programmatic Interface for connecting Client Programs to interface to the Application Server (1007).

The Application Server (1007) manages and maintains the Review Platform via executing machine-instructions as required by the Web Server (1005) or API Server (1006) and utilizing its connection to the Database Server (1009) to retrieve and store information as required.

The Communication Server (1008) is utilized to execute required automated communications to end users via Client Programs using communications technologies such as electronic mail (E-mail), short messaging system (SMS) or push notifications as required by the Application Server (1007).

The Network Based Review Platform (1004) may be accessed by a Client Program (1002) such as an Internet Browser (e.g. Google Chrome distributed by Google Inc of Mountain View, Calif.) or dedicated Client Program such as an Application on a Mobile device (e.g. dedicated compiled application on the Apple iOS platform distributed by Apple Inc of Cuppertino, Calif.) that executes on the Client Machine (1001) and accesses the Network Based Review Platform (1004) via a network (1003) such as the Internet. Other examples of networks that a client may utilize to access the Network Based Review Platform (1004) include a wide area network (WAN), a local area network (LAN), a wireless network such as a cellular data network, or a direct Telephone connection network.

### Exemplary Review System Database

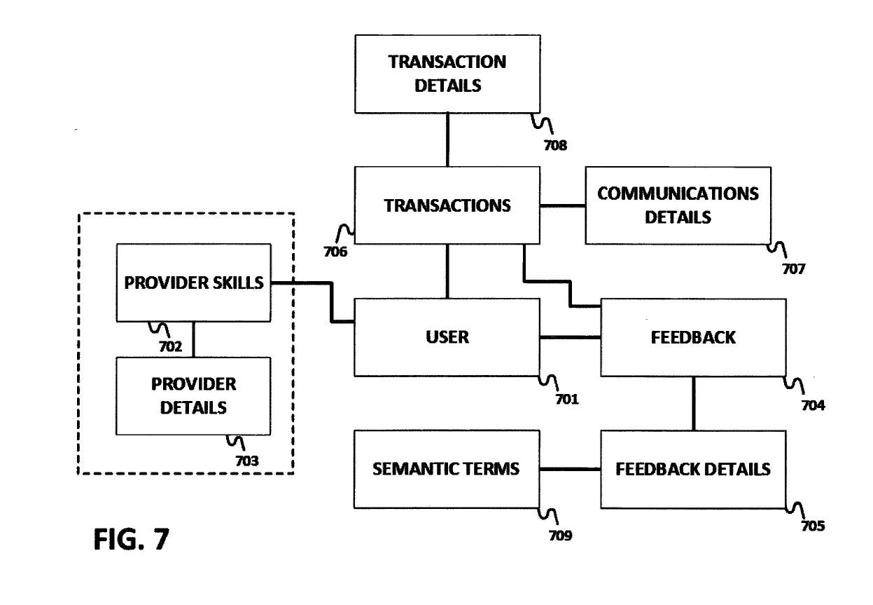

FIG. 7 is a database diagram illustrating an exemplary database that forms the storage system for managing all information stored for the exemplary Review System. The database may, in one variant, be implemented as a relational database, and include a number of tables have entries or records that are linked by indices and keys. In an alternative variant, the database may be implemented as a collection of documents in a document-oriented database, linked by indices. In another alternative variant, the database may be implemented as a collection of objects in an object-oriented data storage system.

Central to the database is the User Table (701) which contains a record for each user of the Review System. Each user represents a potential party within the Review System. For example, a user may operate as a consumer, or supplier of goods and services, or both, within the Review System.

The database optionally may include additional tables for additional properties for a user such as Supplier Skills (702) to detail Skills or Items offered by a user and/or Supplier Details (703) to provide additional properties for those Users offering Services or Goods which may include details such as Supplier Company name and contact details which are in turn linked to the appropriate User record in the User Table (701). The database will include a table for Transactions (706) performed between users which includes a record for each transaction undertaken between each user and links to the user records in the User Table (701).

Additionally a table for the details of each Transaction undertaken will be stored in the Transaction Details Table (708) which will include records for additional details for each Transaction and linked to the appropriate Transaction record in the Transaction Table (706). An additional table for communications between users for each Transaction (e.g. messages between users surrounding the Transaction) are stored in the Communication Details Table (707) and linked to the Transaction record in the Transactions Table (706). The database will also include a table for Feedback (704) the records of which will relate to both user involved in a Transaction and the Transaction record in the Transactions Table (706). Additionally a table for Feedback Details (705) contains records for each item of feedback associated with a particular Feedback record, in this case each item containing a Semantic Term from the Semantic Term Table (709) as the Feedback Detail that in turn links to the Feedback Record.

### An Exemplary Review System Method

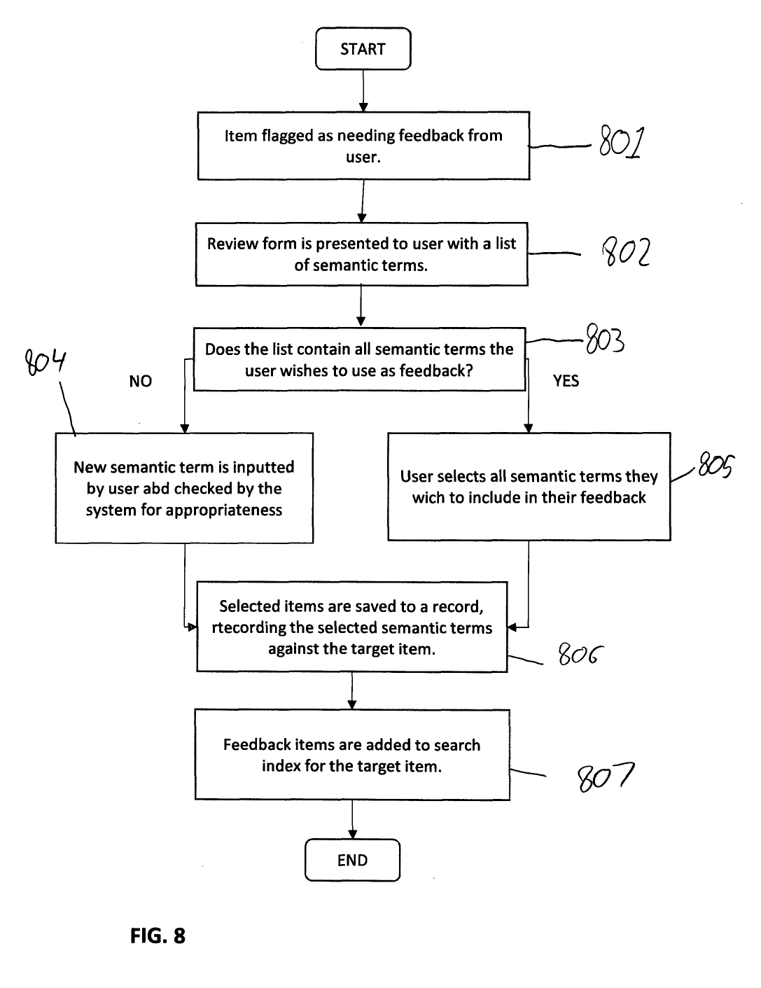

FIG. 8 is a flow diagram illustrating an exemplary method for a feedback system in which a user may review a transaction conducted with another user of an e-commerce system such a Network Based Review Platform (1004) described supra. It is to be noted that variants of the invention are not limited to application to a Network Based Review Platform alone, but may be implemented in any web system in which users of the system interact with one another.

In block 801 the Review System flags a transaction as not having had feedback from the receiving user after completion. If the user has just concluded a transaction with another user (for example, an exchange of goods or services, and marking the transaction as having completed), then they are prompted with a review form (802) once the transaction is marked as completed or upon them connecting to the system again after the transaction has been marked completed.

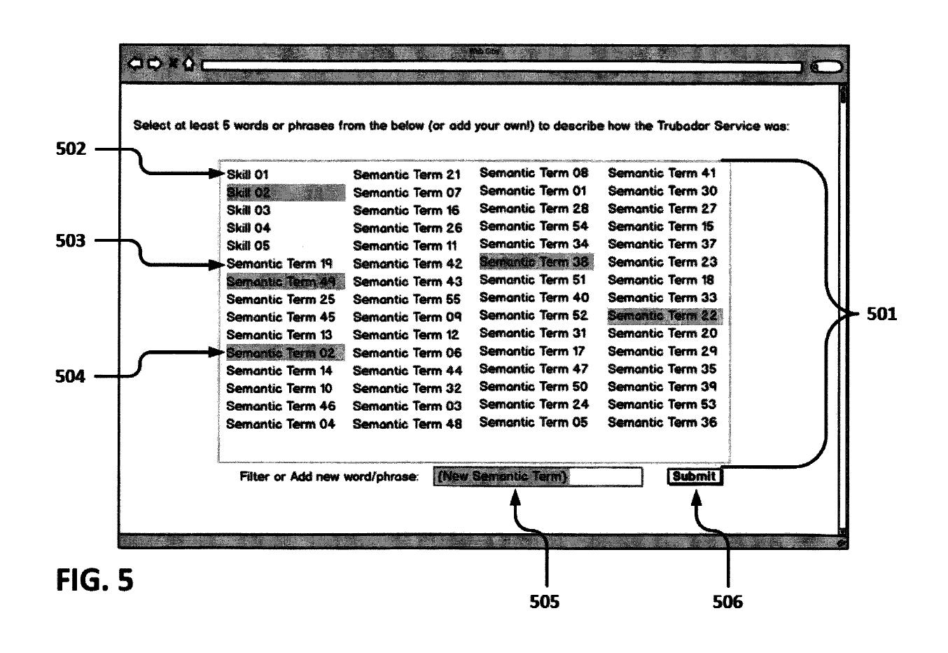

The Review Form as shown in block 802 is displayed to the user once the transaction is marked as completed or upon them connecting to the system again after the transaction has been marked completed. The review form (802) arrays the full list of Semantic Terms possibilities stored in the Database (709). An exemplary illustration of this list in a web browser is shown in FIG. 5 with the list illustrated in 501 with a Semantic Term in the list shown in 503.

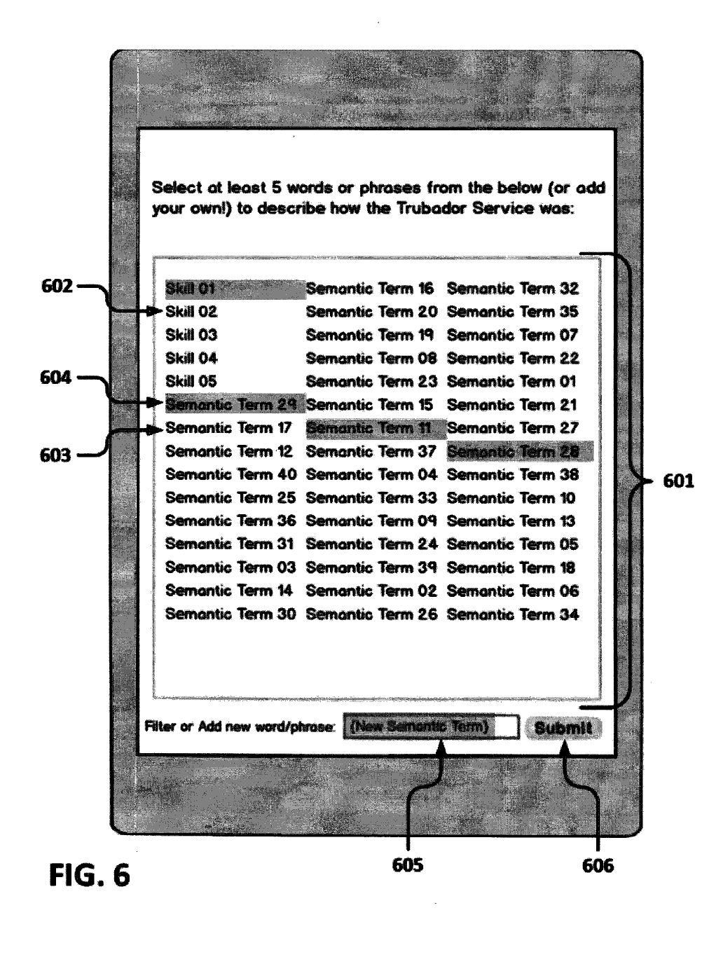

An alternative illustration of this list on an exemplary Mobile Device variant (such as a Smart Phone or Tablet form factor) is shown in FIG. 6 with the list illustrated in 601 with a Semantic Term in the list shown in 603.

As per decision 803, if the list contains all the Semantic Terms the user wishes to select to leave as feedback, then the user selects those terms as per block 805. An illustration of a user selecting these terms in an exemplary web browser variant is shown in FIG. 5 with the selected terms shown in 504. In this variant, when a user is finished selecting terms they submit that selection by pressing the Submit button illustrated in 506.

An alternative illustration of an exemplary Mobile Device variant is shown in FIG. 6 with the select terms shown in 604. In this variant, when a user is finished selecting terms they submit that selection by pressing the Submit button illustrated in 606.

Once the form is submitted, those selected terms are saved as Feedback Details (705) for the Feedback Record (704) as per block 806.

If, as per decision 803, the list does not contain all the Semantic Terms the user wishes to select, they select those Semantic Terms they do wish to leave as feedback, and manually enter new Semantic Terms they wish to leave as feedback, as per block 804. This manual feedback is illustrated in an exemplary web browser variant in FIG. 5 by text box 505, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, clicking on the Submit button illustrated in 506.

An alternative illustration of an exemplary Mobile Device variant is shown in FIG. 6 with the manual entry of new Semantic Terms shown by text box 605, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, clicking on the Submit button illustrated in 606.

Once the form is submitted, the manually entered Semantic Terms are automatically checked by the system for appropriateness to ensure, for example, they are not defamatory or otherwise not deemed acceptable as per block 804. This could be simply done by checking the Terms against a list of unacceptable terms and/or checking the Terms are in the correct language for the user, or are correctly spelled by a spell checking subroutine or by being reviewed by a manual process, or a combination of some or all of these methods of validation.

All selected Skills and Semantic Terms that pass inspection in block 804 are then saved as Feedback Details (705) for the Feedback Record (704) with New Semantic Terms added to the Semantic Terms Table (709), as per block 806.

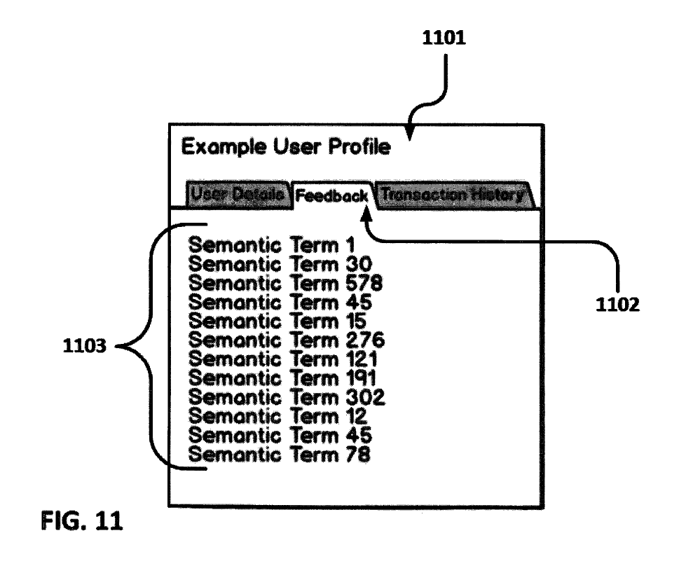

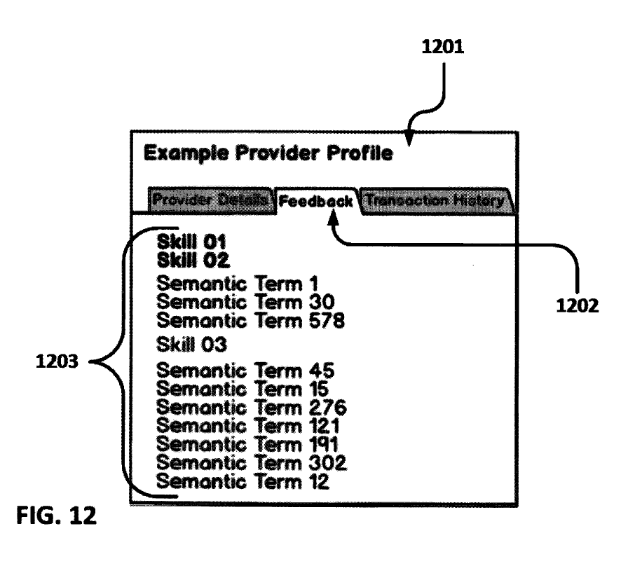

All Feedback Details (705) are then indexed for any searches against the user who was the subject of the feedback, so exposing the feedback to other users of the system as per block 807. In one variant of the invention, an exemplary User Profile (1101) is shown in FIG. 11 for a user who has been reviewed. All feedback for that user is listed under the Feedback tab (1102) as a list in 1103. In this variant, Semantic Terms more frequently picked for the user are shown closer to the top, with less popular terms close to the bottom of the list. In an alternative variant, it may display each Semantic Term individually in either a chronological list based on when the feedback was made, or an alphabetical list of Semantic Terms.

### An Alternative Review System Method

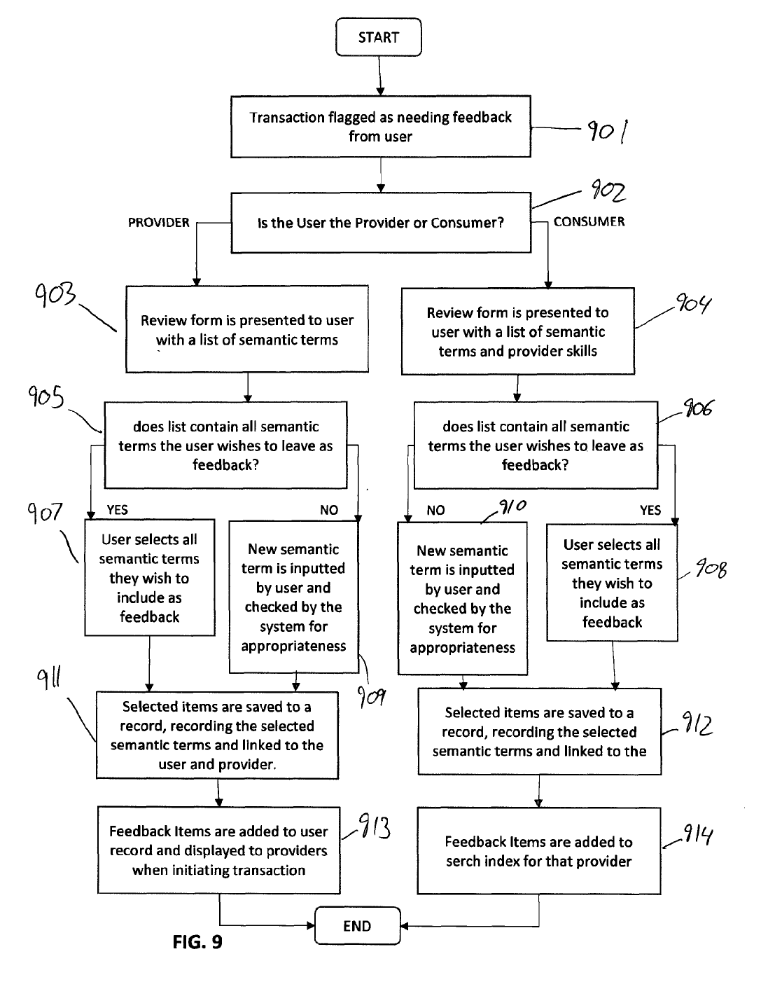

FIG. 9 is a flow diagram illustrating an alternative exemplary method for a feedback system in which a user may review a transaction conducted with another user of an e-commerce system, wherein the reviewer user is a Consumer and the reviewee user is a Supplier providing particular named Skills to the reviewer user, as part of a Network Based Review Platform. It is to be noted that variants of the invention are not limited to the application to a Network Based Review Platform alone, but may be implemented in any web system in which there are two parties engaged in a transaction where feedback is required on one or both of the parties involved in the transaction.

In block 901 the Review System flags a transaction as not having had feedback from the user after completion. If the user has just concluded a transaction with another user (for example, an exchange of services, and marking the transaction as having completed), then dependent on whether the user is a Supplier or Consumer in the transaction (as per decision 902) they will receive a different review form. If the user is a Consumer, as per decision 902, they are presented with Consumer Review Form as shown in block 904 once the transaction is marked as completed or upon them connecting to the system again after the transaction has been marked completed. The review form (904) arrays the full list of Semantic Terms possibilities stored in the Database (709) and arrays all Skills the Supplier user has marked in their User Profile as skills they offer. An exemplary illustration of this list in a web browser is shown in FIG. 5 with the list illustrated in 501 with the Suppliers Skills in the list shown in 502 and the Semantic Terms in the list shown in 503.

An alternative illustration of this list on an exemplary Mobile Device variant (such as a Smart Phone or Tablet form factor) is shown in FIG. 6 with the list illustrated in 601 with the Suppliers Skills in the list shown in 602 and the Semantic Terms in the list shown in 603.

As per decision 906, if the list contains all the Semantic Terms and Skills the user wishes to select to leave as feedback, then the user selects those terms as per block 908. An illustration of a user selecting these terms in an exemplary web browser variant is shown in FIG. 5 with the selected terms shown in 504. In this variant, when a user is finished selecting terms they submit that selection by pressing the Submit button illustrated in 506.

An alternative illustration of an exemplary Mobile Device variant is shown in FIG. 6 with the select terms shown in 604. In this variant, when a user is finished selecting terms they submit that selection by pressing the Submit button illustrated in 606.

Once the form is submitted, those selected terms are saved as Feedback Details (705) for the Feedback Record (704) as per block 912.

If, as per decision 906, the list does not contain all the Semantic Terms the user wishes to select, they select those Semantic Terms they do wish to leave as feedback, and manually enter new Semantic Terms they wish to leave as feedback, as per block 910. This manual feedback is illustrated in an exemplary web browser variant in FIG. 5 by text box 505, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, click on the Submit button illustrated in 506.

An alternative illustration of an exemplary Mobile Device variant is shown in FIG. 6 with the manual entry of new Semantic Terms shown by text box 605, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, click on the Submit button illustrated in 606.

Once the form is submitted, the manually entered Semantic Terms are automatically checked by the system for appropriateness to ensure, for example, they are not defamatory or otherwise not deemed acceptable as per block 910. This could be simply done by checking the Terms against a list of unacceptable terms and/or checking the Terms are in the correct language for the user, or are correctly spelled by a spell checking subroutine or by being reviewed by a manual process, or a combination of some or all of these methods of validation.

All selected Skills and Semantic Terms that pass inspection in block 910 are then saved as Feedback Details (705) for the Feedback Record (704) with New Semantic Terms added to the Semantic Terms Table (709), as per block 912.

All Feedback Details (705) are then indexed for any searches against the Supplier who was the subject of the feedback, so exposing the feedback to other users of the system as per block 914. In one variant of the invention, an exemplary Supplier Profile (1201) is shown in FIG. 12 for a Supplier who has been reviewed. All feedback that Supplier is listed under the Feedback tab (1202) as a list in 1203. In this variant, Skills that have been selected by Reviewing Consumers are highlighted by being shown in bold typeface to show those Skills have been validated by Consumers, and Semantic Terms and Skills more frequently picked for the Supplier are shown closer to the top, with less popular terms close to the bottom of the list. In an alternative variant, it may display each Semantic Term and Skill individually in either a chronological list based on when the feedback was made, or an alphabetical list of Semantic Terms and Skills, or alternatively a separate list of Skills and Semantic Terms sorted by, but not limited to, any of the aforementioned methods.

If the user is a Supplier, as per decision 902, they are presented with Supplier Review Form as shown in block 903 once the transaction is marked as completed or upon them connecting to the system again after the transaction has been marked completed. The review form (903) arrays the full list of Semantic Terms possibilities stored in the Database (709). An exemplary illustration of this list in a web browser is shown in FIG. 5 with the list illustrated in 501 with a Semantic Term in the list shown in 503.

An alternative illustration of this list on an exemplary Mobile Device variant (such as a Smart Phone or Tablet form factor) is shown in FIG. 6 with the list illustrated in 601 with a Semantic Term in the list shown in 603.

As per decision 905, if the list contains all the Semantic Terms the user wishes to select to leave as feedback, then the user selects those terms as per block 907. An illustration of a user selecting these terms in an exemplary web browser variant is shown in FIG. 5 with the selected terms shown in 504. In this variant, when a user is finished selecting terms they submit that selection by pressing the Submit button illustrated in 506.

An alternative illustration of an exemplary Mobile Device variant is shown in FIG. 6 with the select terms shown in 604. In this variant, when a user is finished selecting terms they submit that selection by pressing the Submit button illustrated in 606.

Once the form is submitted, those selected terms are saved as Feedback Details (705) for the Feedback Record (704) as per block 911.

If, as per decision 905, the list does not contain all the Semantic Terms the user wishes to select, they select those Semantic Terms they do wish to leave as feedback, and manually enter new Semantic Terms they wish to leave as feedback, as per block 909. This manual feedback is illustrated in an exemplary web browser variant in FIG. 5 by text box 505, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, click on the Submit button illustrated in 506.

An alternative illustration of an exemplary Mobile Device variant is shown in FIG. 6 with the manual entry of new Semantic Terms shown by text box 605, where a user has entered a New Semantic Term they wish to leave as feedback. A user could enter multiple terms in the same text box if they wished to add more than one new Semantic Term with each term separated by, for example, a comma between new Semantic Terms. Once a user is satisfied they have selected they Semantic Terms and Skills they require and/or entered the new Semantic Terms they wish to leave as feedback, they can submit the form by, in this example, click on the Submit button illustrated in 606.

Once the form is submitted, the manually entered Semantic Terms are automatically checked by the system for appropriateness to ensure, for example, they are not defamatory or otherwise not deemed acceptable as per block 909. This could be simply done by checking the Terms against a list of unacceptable terms and/or checking the Terms are in the correct language for the user, or are correctly spelled by a spell checking subroutine or by being reviewed by a manual process, or a combination of some or all of these methods of validation.

All selected Skills and Semantic Terms that pass inspection in block 909 are then saved as Feedback Details (705) for the Feedback Record (704) with New Semantic Terms added to the Semantic Terms Table (709), as per block 911.

All Feedback Details (705) are then indexed for any searches against the Consumer who was the subject of the feedback, so exposing the feedback to other users of the system as per block 914. In one variant of the invention, an exemplary User Profile (1101) is shown in FIG. 11 for a Consumer who has been reviewed.

All feedback that Consumer is listed under the Feedback tab (1102) as a list in 1103. In this variant, Semantic Terms more frequently picked for the Consumer are shown closer to the top, with less popular terms close to the bottom of the list. In an alternative variant, it may display each Semantic Term individually in either a chronological list based on when the feedback was made, or an alphabetical list of Semantic Terms.

In addition, the variants of the invention facilitate greater system performance by optimizing patterns of feedback. The variants additionally enable clearer articulation of the feedback to users of the system by enabling natural language nuance and avoiding polarised feedback on positive or negative lines (for example selecting ‘friendly and ‘slow delivery’ as feedback) .

The invention is not intended to be restricted to the details of the above described variants. In another variant, for example, the semantic terms may be translated into any language and be displayed in the preferred language of the user providing the feedback, or users reviewing the feedback. Finally, as the Semantic Terms are predefined or automatically reviewed, they can be written to avoid liability under defamation, slander or other local laws of various states.

It will be apparent, however, to one skilled in the art that the present invention may be practiced without some of these specific details. Well-known structures and devices are articulated in block diagram form in other instances. The present invention includes various operations. The operations of the present invention may be performed by hardware components or may be embodied in machine-executable instructions, which may be used to cause a general-purpose or dedicated-purpose processor programmed with the instructions to perform the operations. Alternatively, the operations may be performed by a combination of hardware and software.

1. A system for facilitating the provision of feedback, the system comprising:
a computing means, and
an application resident on the computing means, the application:
defining a list of predetermined review terms,
being adapted to:
display remotely a review form,
receive at the server selections from the list in accordance with reviews made via the form,
statistically analyse the reviews and store statistics thereof on the server, and
make the statistics available for inspection.

2. A system for facilitating the provision of feedback according to claim 1, wherein the computing means is:
a remotely accessible server, or
a distributed ledger.

3. A system for facilitating the provision of feedback according to claim 1, wherein the application is adapted to allow a first user to interact with a second user regarding an event which may be reviewed.

4. A system for facilitating the provision of feedback according to claim 1, wherein the application is adapted to enable a user to create a user profile to which feedback is indexed.

5. A system for facilitating the provision of feedback according to claim 3, wherein an interaction between a first user and a second user is marked as requiring feedback when an interaction has concluded, but no review form has been completed.

6. A system for facilitating the provision of feedback according to claim 1, wherein the system is adapted to allow review terms to be proposed for inclusion on the review form as follows:
the review form is adapted to enable the proposal of one or more review terms,
the application is adapted to determine the appropriateness of a newly proposed review term,
the system being adapted to facilitate the addition by adding the proposed review term to the list if deemed appropriate.

7. A system for facilitating the provision of feedback according to claim 1, wherein the feedback system is adapted to determine the appropriateness of a proposed review term by employing the following steps:
comparing the proposed review term to a list of unacceptable terms,
checking the proposed review term is in the correct language for the supplier,
ensuring the proposed review term is spelt correctly by using a spell checking subroutine,
undertaking a manual review of the proposed review term, or
a combination of some or all of the above steps.

8. A system for facilitating the provision of feedback according to claim 1, including:
an application server,
a web server,
an API server,
a communication server, or
a database server.

9. A system for facilitating the provision of feedback according to claim 1, wherein the system for facilitating feedback is accessed through a client program, a wide area network, a local area network, or a wireless network.

10. A system for facilitating the provision of feedback according to claim 1, wherein the system is adapted to allow a filtering of results based on the statistical analysis of previous reviews.

11. A system for facilitating the provision of feedback according to claim 1, wherein a review term can be descriptive of a skill or product provided by a reviewee.

12. A system for facilitating the provision of feedback according to claim 1, wherein the system is adapted to translate the review terms into another language.

13. A method to facilitate the operation of a feedback system wherein a reviewer can review a reviewee, the method comprising of the following steps, the feedback system:
displaying to the reviewer a review form on a display,
enabling the reviewer to select one or more predetermined review terms from the review form to provide feedback to the reviewee using a human interface device,
receiving the selection of review terms made by the consumer,
statistically analysing the review terms selected by the consumer and storing the statistics thereof, and
making the statistics available for inspection.

14. A method to facilitate the operation of a feedback system wherein a supplier can review a consumer according to claim 13, wherein the reviewer and reviewee relationship can be between a consumer and supplier, a supplier and consumer or peer to peer.

15. A method for facilitating the provision of feedback according to claim 13, wherein the application is adapted to allow the creation of a profile by a reviewer and/or reviewee.

16. A method for facilitating the provision of feedback according to claim 13, wherein the system enables the reviewer and reviewee to interact.

17. A method for facilitating the provision of feedback according to claim 16, wherein an interaction between a reviewer and reviewee is identified as requiring feedback when the interaction has concluded, but no feedback has been provided.

18. A method for facilitating the provision of feedback according to claim 13, wherein a method is provided to allow for review terms to be proposed for inclusion on the review form, the steps are as follows:
the system for facilitating the provision of feedback enabling the reviewer or reviewee to propose one or more new review terms for inclusion on the review form,
the system allowing for the input of multiple proposed review terms simultaneously by enabling the reviewer or reviewee to indicate the beginning/end of each proposed review term,
the system for facilitating the provision of feedback having means to determine the appropriateness of a newly proposed review term,
the system for facilitating the provision of feedback adding the proposed review term to the list, if deemed appropriate.

19. A method for facilitating the provision of feedback according to claim 18, wherein the feedback system is adapted to determine the appropriateness of a proposed review term by employing the following steps:
comparing the proposed review term to a list of unacceptable terms,
checking the proposed review term is in the correct language for the supplier,
ensuring the proposed review term is spelt correctly by using a spell checking subroutine,
undertaking a manual review of the proposed review term, or
a combination of some or all of the above steps.

20. A method for facilitating the provision of feedback according to claim 13, wherein the review terms on the review form are presented in an order determined by:
popularity,
chronology, or
alphabetical order.

21. (canceled)

22. (canceled)

23. A method for facilitating the provision of feedback according to claim 13, wherein means are provided to enable the review terms to be translated into any language, and/or the preferred language of the consumer or supplier providing the feedback, or the prospective consumer/supplier reading the feedback.
